(19) United States
(12) Patent Application Publication
(10) Pub. No.: US 2004/0228385 A1
(43) Pub. Date: Nov. 18, 2004

(54) Method and apparatus for generating laser radiation on the basis of semiconductors

(76) Inventors: Volker Raab, Potsdam (DE); Ralf Menzel, Berlin (DE)

Correspondence Address: KLAUS J. BACH & ASSOCIATES, PATENTS AND TRADEMARKS, 4407 TWIN OAKS LANE, MURRYSVILLE, PA, 15668, US

(21) Appl. No.: 10/856,642

(22) Filed: May 28, 2004

Related U.S. Application Data
(63) Continuation-in-part of application No. PCT/EP02/12400, filed on Nov. 6, 2002.

(30) Foreign Application Priority Data
Dec. 12, 2001 (DE) 101 61 076.9

(51) Int. Cl. H01S 3/10; H01S 3/082

(52) U.S. Cl. 372/97

(57) ABSTRACT

In a device and method for generating laser radiation based on semiconductors, with which laser light of a high beam quality can be produced, the device producing laser radiation has a reflective element, which has no influence on the divergence of the light exiting the semiconductor and is placed at a distance from the semiconductor at which the arrangement forms an external unstable resonator, the divergent light exiting the semiconductor.

This is a Continuation-in-Part application of International Application PCT/EP02/12400 filed Nov. 6, 2002 and claiming the priority of German application 101 61 076.9 filed Dec. 12, 2001.

### BACKGROUND OF THE INVENTION

The invention relates to a method and apparatus for generating laser radiation on the basis of semiconductors by stimulated emission in a semiconductor.

Because of their small apparatus sizes and high efficiencies, semiconductor lasers are already used in eye surgery, in the area of bio-stimulation, photography and in other areas. Semiconductor lasers may also be used in areas of microsurgery, the pumping of fiber lasers for light sources in the visible spectral range, direct frequency conversion into the blue spectral area, for plastic welding, providing marks, for inscription applications, the pumping of microchip laser and for spectroscopy. For such applications, the lasers require a high output power and a high radiation or beam quality.

In connection with semiconductor lasers, the charge inversion required for the laser operation is generated between the conductor band and the valence band. Electrons which are lifted by the pumping process from the valence band to the conductor band generate, upon completion of their natural life cycle, the so-called recombination radiation by spontaneous emission. By the stimulated emission in an optical resonator, coherent laser radiation is generated.

An inversion in a semiconductor can be achieved by optical pumping, by bombardment with highly energetic electrons and by injection of minority carriers in a pn-transition. In a diode laser, which is the technically most important laser among the semiconductor lasers, two differently doped semiconductors are joined to a pn-diode and form in the contact area a so-called barrier layer which, after a short relaxation period, does not permit any further recombination of electrons and holes. By the application of an outer voltage, a diode current is maintained which constantly injects electrons and holes into the barrier layer. The electrons recombine with the holes and, as a result, emit radiation. This recombination radiation is therefore a direct result of the injection current.

The processes described occur in the same way also in common semiconductor diodes and light emitting diodes. The essential different with laser diodes resided in the fact that, by the targeted selection of the semiconductor materials and the doping concentrations, the number of the radiation-free transitions are minimized and the number of radiation-generating transitions are maximized and that, furthermore, the radiation emitted is amplified in a resonator. The resonator is generally formed by planar-parallel end surfaces of high optical quality of a crystal.

Diode lasers, however also have properties which are disadvantageous for the spectroscopy, namely a low spectral purity and an unclean radiation profile and no continuous detunability. Nevertheless, diode lasers are often used in spectroscopic applications as, with suitable optical and electrical control mechanisms, the frequency the beam and the detunability properties can be substantially improved. The reason for the poor beam quality is the fact that, with semiconductor lasers, transversal modes of different orders develop in the optical resonator. They are highly important for the achievable beam quality. They are the result of infraction and interference phenomena and reflect the spatial distribution of the oscillation energy in the laser resonator.

Various methods and apparatus for a beam quality improvement of diode lasers, particularly in high power diode lasers with broad area geometry, are known. For example, by means of external resonators, one or a few transversal modes are selected in order to be able to suppress as many other transversal modes as possible, thereby to improve the beam quality. All resonator arrangements known to be used for that purpose include several and sometimes complicated and expensive optical components.

The high material costs and the high assembly and mounting expenses are disadvantageous. Furthermore, these arrangements are highly sensitive to possible misalignments.

It is furthermore known to replace the broad area lasers by seed lasers and/or trapezoidal amplifiers in order to improve the beam quality. It is however disadvantageous in connection with these apparatus that they too require high material and construction expenses. It is furthermore known to use external resonators comprising lenses, etalons, and/or phase conjugating mirrors. However, those are either unstable at high pump flows or they are very difficult to manufacture or complicated and therefore expensive.

It is therefore the object of the present invention to provide an apparatus for the generation of laser beams on the basis of semiconductors, by which laser light of high beam quality can be generated, wherein the apparatus is relatively inexpensive to manufacture and is less sensitive to de-adjustments than the known apparatus. Furthermore, a method for the generation of laser radiation on the basis of semiconductors is to be provided which eliminates the disadvantages of the methods known in the state of the art.

### SUMMARY OF THE INVENTION

In a device and method for generating laser radiation based on semiconductors, with which laser light of a high beam quality can be produced, the device producing laser radiation has a reflective element, which has no influence on the divergence of the light exiting the semiconductor and is placed at a distance from the semiconductor at which the arrangement forms an external unstable resonator, the divergent light exiting the semiconductor is partially reflected and coupled back into the semiconductor.

It is a particular advantage of the invention that, with the apparatus and the method according to the invention, a high beam quality of the light emitted from the semiconductor laser is obtained with the use of only a minimal number of optical components. To this end, the apparatus according to the invention includes a semiconductor with a reflective element arranged outside the semiconductor for forming an external unstable resonator. It is not necessary that the reflecting element has an influence on the divergence of the light emitted from the semiconductor chip. The reflecting element is arranged at such a distance from the semiconductor chip that the arrangement forms an external, unstable resonator and furthermore partially reflects the divergent light emitted from the semiconductor chip back to the semiconductor so that it is coupled back into the semiconductor. The formation of an external unstable resonator does not mean that there are no focusing elements but rather only that those element are not sufficient to stabilize the resonator.

Preferably, the width (FHWM) of the light back-coupled by the external resonator which is measured as full width at half the intensity, exceeds the width (FHWM) of the input/output opening of the semiconductor laser by at least three times.

The semiconductor laser may be an edge emitting high power diode laser or a vertical emitter (VCSL). The apparatus according to the invention may additionally have a cylinder lens for the reduction of the light divergence.

With an edge-emitting, high-power diode laser, the arrangement according to the invention may additionally include a cylinder lens for the reduction of the high light divergence.

The reflecting element is preferably a planar mirror. But the reflecting element may also be a curved mirror. The surface-normal of the planar mirror may be disposed at a finite angle with respect to the surface-normal to the semiconductor chip. This angle may assume a value which is determined by the transversal modes of higher order of the semiconductor laser or which is preferred by the electrode contact with the semiconductor laser.

The distance d between the planar mirror and the semiconductor chip should fulfill the condition 0.1<d×λ/D²<10, wherein D is the width of the emitting facet of the semiconductor chip, and λ is the emission wavelength. Preferably, the input/output opening of the semiconductor chip has a length of between 100 μm and 1 mm and the distance d between the semiconductor chip and the planar mirror is between 3 cm and 10 cm.

The apparatus according to the invention may additionally have an aperture for the selection of preferred diffraction maxima.

For the frequency stabilization, the reflecting element may be a frequency selective element, such as a grating. Furthermore, the apparatus according to the invention may include additional frequency selective elements for example an etalon.

In a preferred embodiment, the semiconductor chip includes a modulated gain profile and/or an refractive index profile. This can be generated selectively by a suitably selected electrode contact, by additional layers in the epitaxy, by etching processes or by the thickness modulation of individual layers. In a particularly preferred embodiment, the semiconductor includes a low-resistance contact strip diffused into the semiconductor chip which otherwise consists of high-resistance semiconductor material. The sine of the optimal angle for laser operation is then formed as the ratio of half the wave length and the modulation period or a multiple of this ratio.

In accordance with the invention, a semiconductor laser with an external unstable resonator can be used for improving the beam quality of the emitted laser light. In addition, a semiconductor laser with an external unstable resonator can be used for influencing the spectral properties of the emitted laser light.

Below, the invention will be described on the basis of examples shown in the accompanying drawings.

### BRIEF DESCRIPTION OF THE DRAWINGS

FIG. 1 is a schematic representation of an apparatus according to the invention for operating an edge-emitting wideband laser along its optical axis (on-axis),

FIG. 2 is a schematic representation of an arrangement of an edge emitting broad area laser with emission outside its optical axis (off axis),

FIG. 3 shows schematically an arrangement of an edge-emitting broad area laser with emission outside its optical axis (off-axis) including a grating as a reflective element and an etalon for frequency stabilization,

FIG. 4 shows schematically a semiconductor laser with a gain profile having a low resistance contact strip diffused into the high-resistance semiconductor material.

### DESCRIPTION OF PREFERRED EMBODIMENTS

The invention is based on the concept of combining a gain medium with an external, unstable resonator. Unstable laser resonators which, according to conventional laser theory, have no stable laser mode, can however form a well-defined and timely non-variable (stationary) laser mode if the losses can be compensated for with high amplification of the active medium.

The use of unstable laser resonators in connection with semiconductor lasers is not known so far. It is surprising that, with semiconductor lasers, a good beam quality can be achieved at high power outputs if the semiconductor chip in addition to a cylinder lens is combined only with a single planar mirror for the feedback. The mirror however has to fulfill special requirements concerning angle and distance. Basically, it is to be expected that such a feedback by means of an unstable laser resonator has too many losses to achieve laser operation. However, this is not the case, particularly not in connection with high-power diode lasers, since the high power losses can be tolerated. As a result, further elements such as lenses, grating mirrors and phase conjugators are not needed.

The distance d between a semiconductor chip and the planar mirror must, on one hand, be short enough to keep the losses on a tolerable level, on the other hand, this distance must be large enough such that the wave front of the freely propagating light approximates that of a flat wave. This latter approximation is better the larger the distance is between the semiconductor chip and the mirror. The wave reflected from the mirror is cut and amplified by the semiconductor chip which acts as an aperture.

For an optimal operation, the distance between the chip and the mirror must be so selected that, on one hand, the losses are low and, on the other hand, the beam quality is as high as possible. The optimal distance depends on the chip geometry, the amplification properties, the wavelength, the quality of the mirror, the selected transversal mode and possibly the presence of other optical elements which have an influence on the divergence or intensity distribution.

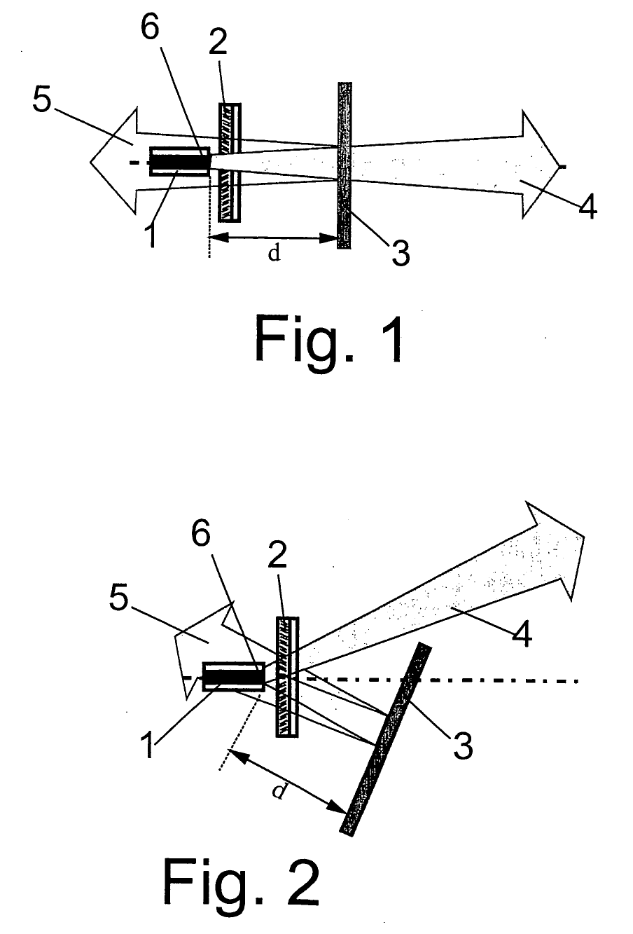

FIG. 1 is a schematic representation of an apparatus according to the invention for generating laser light of high beam quality using a semiconductor chip 1. The light emitted from the semiconductor chip 1, which is an edge-emitting broad-area laser, is directed onto a partially transparent planar mirror 3. A part of the light passes through this partially transparent mirror 3 and is available as useable light for certain applications. The remaining reflected feedback light 5 is returned to the semiconductor chip 1. Only the part of the feedback light 5, which reaches the amplifying area of the semiconductor chip 1, contributes to the laser operation. This area is determined by the input/output aperture 6. It is the central area of the emission whose intensity variations are much smaller than the intensity itself. The wave front, also the local propagation direction in the vicinity of the input/output aperture 6, is spherical. This spherical wave front has only a small curvature over the width of the emitter. With edge-emitting laser diodes, a cylinder lens 2 with short focal length is advantageous since it reduces the high divergence of the light in the plane normal to the epitaxy and therefore increases the feedback. A corresponding construction for the vertical emitter (VCSVL) would include the same components but a cylinder lens 2 may not be needed because of the fact that the laser radiation of the vertical emitter is emitted through the surface of the laser diode.

FIG. 2 shows schematically an apparatus for generating a high-quality beam with an edge emitting broad area laser which does not emit along its optical axis (off-axis). Part of the laser light emitted by the apparatus is returned to the semiconductor chip 1 by way of the planar mirror 3. This feedback-light is amplified and leaves the semiconductor chip 1 in accordance with the laws of reflection. The angle is defined in this arrangement by the connecting line between the semiconductor chip 1 and the surface normal of the planar mirror 3. By tilting one of the two elements, the angle can be adjusted. The explanations concerning the wave front intensity and the operation of the vertical transmitter are applicable also in this case like in the case of on-axis emission of the laser light.

For the required distance, which on one hand should be sufficiently short to keep the losses low and, on the other hand, long enough to achieve a high beam quality, the following estimation may be provided:

0.1<d×λ/D²<10, wherein D is the width of the input/output opening 6 of the semiconductor, λ is the emission wavelength and d is the distance between the semiconductor chip 1 and the planar mirror 3.

This estimation applies to the presence of a planar mirror without further beam-forming elements such as lenses that may be present.

Otherwise, the lengths and, respectively, distances must be converted in accordance with the laws of optical imaging. With the apparatus according to FIG. 1, or respectively, FIG. 2, for the resulting light beam propagation factor of M²<2 can be achieved.

A further improvement of the beam quality up to values close to M²=1 can be achieved if, of the resulting light which corresponds almost to that of a homogeneously illuminated rectangular aperture, by means of a resonator-external aperture only the central diffraction maximum is permitted to pass.

The resulting angular distribution corresponds to that of a hard slit aperture. A resulting beam propagation factor of about 2 represents a substantial improvement in comparison with the propagation factors of typical broad area diode lasers of about 30 to 60.

Basically, the behavior described above can then be observed when the width of the light distribution (FHWM) of the back-coupling light is, upon re-entering the amplification area, wider than the amplification area itself.

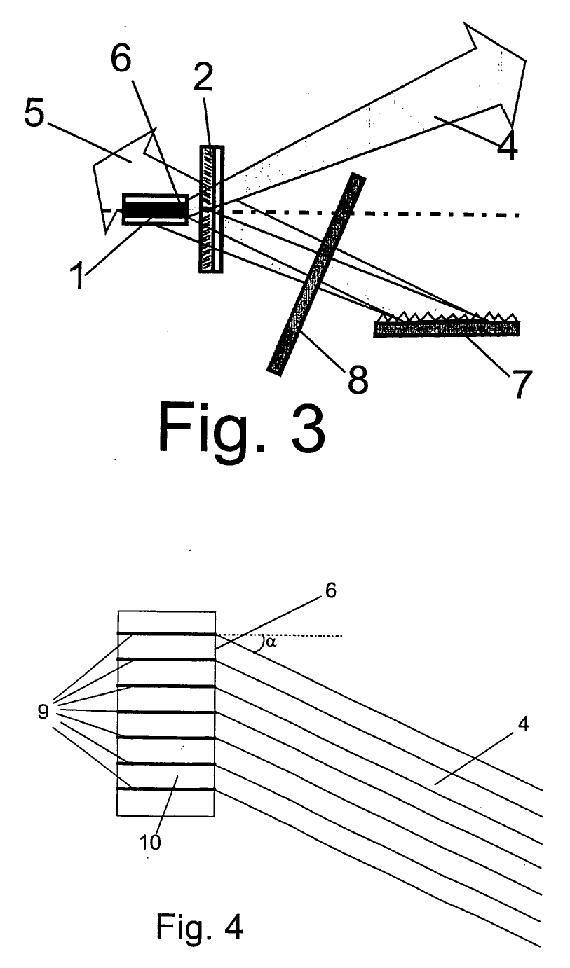

FIG. 3 shows schematically an arrangement for generating a high beam quality with an edge emitting broad area laser which does not emit along its optical axis (off-axis) wherein the reflective element is a grating 7. Additionally, the arrangement includes an etalon 8 for frequency stabilization. Also, in this arrangement, the apparatus according to the invention forms an unstable resonator. Basically, it should be expected that the feedback with the apparatus according to the invention as shown in FIGS. 1 to 3 results in losses which are too high to achieve laser operation. Surprisingly, however, it has been found that, with the use of semiconductor lasers with an external unstable resonator, laser light of high beam quality can be obtained and the arrangement requires only few optical components.

In a preferred embodiment, the semiconductor chip 1 has a modulated gain profile and/or an refractive index profile. This can be generated selectively by appropriately selected electrode contacts, by additional layers in the epitaxy, by etching processes or by thickness modulations of individual layers. It has been found, that, with such a semiconductor, a particularly efficient laser operation with an external unstable resonator can be achieved. In a particularly preferred embodiment, the semiconductor 20 includes a low resistance contact strip 9 diffused into an otherwise high-resistance semiconductor material as shown in FIG. 4. The sine of the optimal emission angle for laser operation is then obtained as the ratio of half the wavelength and the modulation period or a multiple of this ratio.

The invention is not limited to the embodiment represented herein. Rather it is possible to provide further embodiments by combinations and modifications of the means and features described herein without leaving the frame of the invention.

What is claimed is:

1. A method for generating laser radiation on the basis of semiconductors by stimulated emission in a semiconductor (1) so as to generate laser light leaving the semiconductor through an input/output aperture (6) thereof, comprising the steps of: reflecting a part of the laser light emitted from the semiconductor (1) by way of an external reflecting element (3) back to said semiconductor (1) and coupling a part of the light reflected back to the semiconductor (1) back into the semiconductor (1) by way of said input/output aperture (6) of the semiconductor (1), thereby providing for the stimulated emission in said semiconductor (1) by way of an external unstable resonator.

2. A method for generating laser radiation according to claim 1, wherein said reflection of a part of the laser light emitted from said semiconductor (1) is reflected by one of a planar and a curved mirror.

3. A method according to claim 2, wherein said planar mirror (3) has a surface normal, which extends at an angle to a surface normal of said semiconductor.

4. A method according to claim 1, wherein at least one diffraction maximum—excepting the central diffraction maximum—is masked out by a resonator-external aperture.

5. A method according to claim 2, wherein the distance d between said semiconductor (1) and said planar mirror (3) satisfies the condition 0.1<d×λ/D²<10, wherein D is the width of the input/output aperture (6) of the semiconductor (1) and λ is the emission wavelength.

6. An apparatus for generating laser radiation, comprising a semiconductor (1) and a radiation-reflecting element (3) arranged outside the semiconductor (1) for forming an external unstable resonator.

7. An apparatus according to claim 6, wherein said semiconductor element has an input/output aperture and the light coupled back by the external resonator has a beam width (FHWM) which is measured as full width at half intensity and which exceeds the width (FHWM) of said input/output aperture of said semiconductor by the factor of 3.

8. An apparatus according to claim 6, wherein said semiconductor (1) is one of an edge-emitting high-power diode laser and a vertical emitter laser (VCSL).

9. An apparatus according to claim 8, wherein said apparatus additionally includes a cylinder lens (2).

10. An apparatus according to claim 6, wherein said reflecting element is one of a planar and a curved mirror.

11. An apparatus according to claim 10, wherein said planar mirror (3) has a surface normal, which extends at a finite angle with respect to a surface normal of said semiconductor (1).

12. An apparatus according to claim 11, wherein said angle between the surface normals has a value which is determined by transversal modes of higher order of the semiconductor.

13. An apparatus according to claim 12, wherein the angle between said surface normals has a value corresponding to that of the transversal mode which is preferred by the electrode contacts of the semiconductor laser.

14. An apparatus according to claim 6, wherein the distance d between the reflective element (3) and the semiconductor (1) satisfy the condition 0.1<d×λ/D²<10, wherein D is the width of said input/output aperture (6) of said semiconductor (1) and λ is the emission wavelength.

15. An apparatus according to claim 6, wherein the input/output opening of said semiconductor (1) has preferred a length of 100 μm to 1 mm and the preferred distance between the semiconductor (1) and the reflecting element (3) is 3 to 10 cm.

16. An apparatus according to claim 6, wherein said apparatus includes an additional aperture in the form of an aperture or mode stop.

17. An apparatus according to claim 6, wherein said reflecting element (3) is a frequency-selective element in the form of a grating (7).

18. An apparatus according to claim 6, wherein said apparatus includes at least one frequency selective element in the form of an etalon.

19. An apparatus according to claim 6, wherein said semiconductor has at least one of a gain profile and an infraction index of refraction profile.

20. An apparatus according to claim 19, wherein said gain profile has a low resistance contact strip formed in an otherwise high-resistance semiconductor material.
